(19) United States
(12) Patent Application Publication
(10) Pub. No.: US 2022/0279768 A1
(43) Pub. Date: Sep. 8, 2022

(54) JIG HEAD FISHING LURE

(71) Applicant: Steve PARKS, Burleson, TX (US)

(72) Inventor: Steve PARKS, Burleson, TX (US)

(21) Appl. No.: 17/684,222

(22) Filed: Mar. 1, 2022

Related U.S. Application Data
(60) Provisional application No. 63/157,977, filed on Mar. 8, 2021.

(51) Int. Cl. A01K 85/00

(52) U.S. Cl. CPC A01K 85/1813; A01K 85/1867

(57) ABSTRACT

The jig head comprises a rear, a curved intermediate portion, a main body, lateral recesses, and a hook, the hook comprising a base. The jig head comprised an eye for attachment to a fishing line. The lateral recesses are positioned adjacent to sides of the hook proximate to the curved intermediate portion and are structured and arranged to receive an extension portion of a bait such as a soft plastic bait comprising an artificial crab. The hook extends from an upper surface of the rear. A conical portion surrounds the base of the hook. A ridge extends outward from the main body. The ridge, the hook, and the conical portion define a space adapted to receive a portion of the bait. The hook, the conical portion, the recesses, the ridge, and the curved intermediate portion, separately and in combination, secure the bait in a desired position.

This application claims the benefit of U.S. Provisional patent application Ser. No. 63/157,977 filed Mar. 8, 2021, the contents of which are incorporated by reference herein in their entirety.

### BACKGROUND OF THE INVENTION

### 1. Field of the Invention

The present invention relates generally to fishing hooks and specifically to a jig head that permits a plastic bait, such as a soft plastic crab, to remain in a desired position.

### 2. Description of the Prior Art

Fishing with artificial lures is convenient and productive for the angler. Live bait must be kept alive and replenished frequently from a bait shop or other source. Artificial lures do not require the same care. Many artificial lures are attractive to fish when fished with skill and are productive in catching fish.

One type of lure includes a jig head. The jig head provides both a hook and a weight. The weight allows the lure to be cast out some distance and provides control of depth of the lure on retrieval. One type of jig head is adapted to receive a soft plastic bait comprising a crab. Although referred to as a jig “head”, a jig head used for a crab has a rear portion rather than a head portion. This is because a crab bait is reeled with the crab moving backwards through the water to match the natural movements of live crabs. However, because a soft plastic crab is relatively large, conventional jig heads adapted for use with a soft plastic crab cause the bait to undesirably move from a desired position, thus, causing an unnatural presentation.

What is needed is a jig head that permits a plastic bait, such as a soft plastic crab, to remain in a desired position on the jig head.

### SUMMARY OF THE INVENTION

The present invention permits a soft plastic bait, such as a crab, to be secured in a desired position. The jig head of the preferred embodiments comprises a rear, a curved intermediate portion, a main body, and a hook. A rear eye for attachment to a fishing line extends from a lower outer surface of the rear. The hook extends from an upper outer surface of the rear. Surrounding a base of the hook is a conical portion. The hook has a shank, a bend and a point. The shank and the bend lie in a plane. For most hooks, the point will lie in the same plane.

Beneath a portion of the shank, proximate to the rear and curved intermediate portion, is a ridge which extends outward from the main body. The ridge aids in maintaining a soft plastic bait, such as a crab, in position.

In preferred embodiments, the jig head has a curved outside configuration when viewed from the side such that the curved intermediate portion curves downward from the rear to the main body and outward with reference to a central longitudinal axis.

In preferred embodiments, the jig head comprises lateral recesses positioned on each side of hook proximate to the curved intermediate portion. Such lateral recesses are adapted to receive respective extension portions of a soft plastic bait.

The jig head configuration of the preferred embodiment permits a soft plastic bait such as a crab to be secured in a desired position. For example, when a plastic bait is placed in position, the ridge indents into the bait and helps prevent the plastic bait from spinning. In addition to the hook, the conical portion permits a larger surface area to extend into the bait at the base of the hook. Likewise, the lateral recesses provide a surface that help prevent the bait from moving from a desired position. When cooperative extension portions of a bait are inserted in these recesses the bait is further secured. Additionally, contours of the curved intermediate portion further help maintain the bait in position. Thus, the hook, the conical portion, the recesses, and the curved intermediate portion separately, and in combination, secure the bait in a desired position.

### BRIEF DESCRIPTION OF THE DRAWINGS

FIG. 1 is plan view of the jig head of the present invention, in accordance with a preferred embodiment.

FIG. 2 is left elevation view of a portion of the jig head of FIG. 1.

FIG. 3 is a rear and side isometric view of the jig head of FIG. 1.

FIG. 4 is a front and side isometric view of the jig head of FIG. 1.

FIG. 5 is the plan view of the jig head of FIG. 1, with an artificial bait shown in phantom in a preferred position on the jig head.

### DESCRIPTION OF THE PREFERRED EMBODIMENT

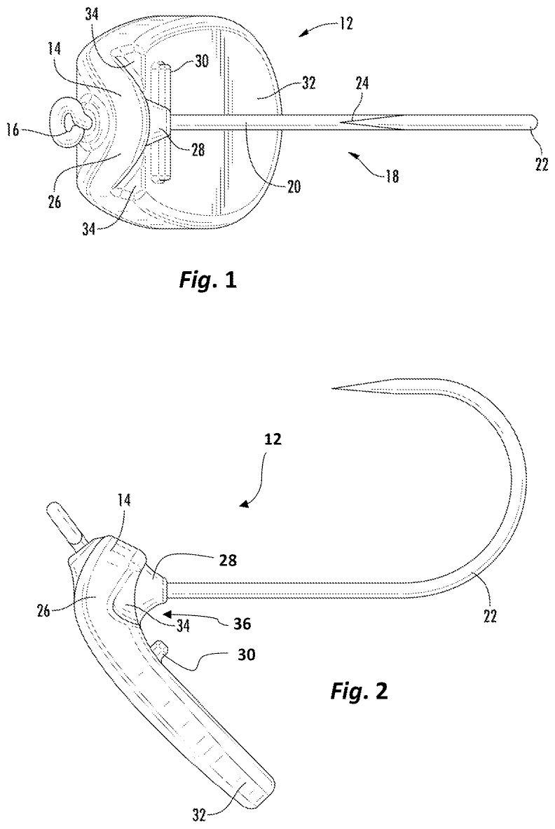

Referring to FIGS. 1-5, there is shown the jig head 12 in accordance with preferred embodiments. As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation. The detailed description illustrates by way of example, not by way of limitation, the principles of the invention. This description will clearly enable one skilled in the art to make and use the invention, and describes several embodiments, adaptations, variations, alternatives, and uses of the invention, including what is presently believed to be the best mode of carrying out the invention.

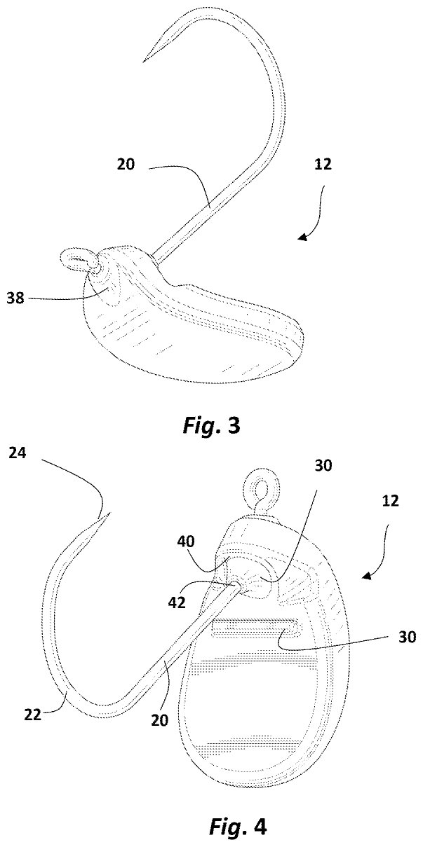

Referring to the figures, the jig head 12 of the preferred embodiment generally comprises a rear 14, a curved intermediate portion 26, a main body 32, and a hook 18. A rear eye 16 for attachment to a fishing line extends from a back portion 38 of the rear 14 (FIG. 3). The hook 18 extends from an upper surface 40 of the rear 14. Surrounding a base 42 of the hook 18 is a conical portion 28. The hook 18 has a shank 20, a bend 22 and a point 24. The shank 20 and the bend 22 lie in a plane. For most hooks, the point 24 will lie in the same plane (FIG. 1).

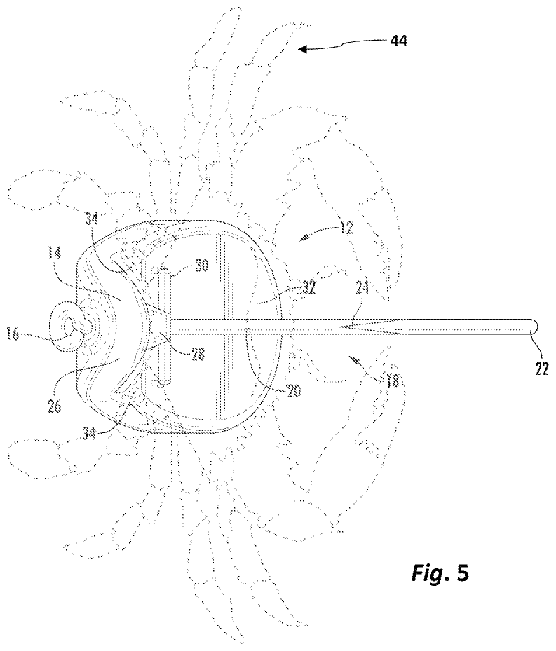

Beneath a portion of the shank 20, proximate to the rear 14 and curved intermediate portion 26, is a ridge 30 which extends outward from the main body 32. Thus, the ridge 30, the hook 18, and the conical portion 28 define a space 36 (FIG. 2). The space 36 is adapted to receive a portion of a soft plastic bait 44. The ridge 30 aids in maintaining the soft plastic bait 44, such as a crab, in position as shown, for example, in FIG. 5. In the preferred embodiment, the ridge 30 is integrated into main body 32 such that the ridge 30 and main body 32 are formed from a single piece of material. However, the ridge 30 can be a separate piece attached to the main body 32.

Referring to FIG. 2, the jig head 12 of the preferred embodiment has a curved outside configuration when viewed from the side such that the curved intermediate portion 26 curves downward from the rear 14 to the main body 32 and, referring to FIG. 1, outward with reference to a jig head 12 central longitudinal axis.

Referring to FIG. 1, the jig head 12 comprises lateral recesses 34, 34 positioned on each side of hook 18 proximate to the curved intermediate portion 26. The lateral recesses 34, 34 of the preferred embodiment are adapted to receive respective extension portions of the soft plastic bait, as shown in FIG. 5, for example.

The jig head 12 configuration of the preferred embodiment permits the soft plastic bait 44 such as a crab to be secured in a desired position. For example, when the plastic bait is placed in position, the ridge 30 indents into the bait and helps prevent the plastic bait 44 from spinning. In addition to the hook 18, the conical portion 28 permits a larger surface area to extend into the bait 44 at the base of the hook 18. Likewise, the lateral recesses 34, 34 provide a surface that help prevent the bait 44 from moving from a desired position. When cooperative extension portions of the bait 44 are inserted in these recesses 34, 34 the bait 44 is further secured. Additionally, contours of the curved intermediate portion 26 further helps maintain the bait 44 in position. Thus, the hook 18, the conical portion 28, the recesses 34, 34, the ridge 30 and the curved intermediate portion 26 separately and in combination, secure the bait in a desired position.

The jig head 12 of the preferred embodiment is typically made of metal such as lead or steel. In the preferred embodiment, the jig head is made of lead.

In use, the bait 44 is threaded over the hook 18 until the conical portion 28 penetrates a portion of the bait 44 and such that an underside of the bait 44 rests against the ridge 30 and such that extension portions of the bait 44 are positioned within the lateral recesses 34, 34. Though fishing techniques are highly individualized, the bait 44 is retrieved by reeling in the fishing line attached to the rear eye 16 such that the jig head 12 and bait 44 move “backwards” through water in a similar fashion as a live crab moves through water.

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of this disclosure.

1. A jig head for fishing, the jig head comprising:
a rear, a curved intermediate portion, a main body, and a hook, the hook comprising a base;
the hook extending from an upper surface of the rear;
the jig head further comprising a conical portion and a ridge;
the conical portion surrounding the base of the hook;
the ridge extending outward from the main body;
the ridge, the hook, and the conical portion defining a space.

2. The jig head of claim 1, further comprising lateral recesses, the lateral recesses being positioned adjacent to sides of the hook proximate to the curved intermediate portion.

3. The jig head of claim 1, further comprising an eye adapted for attachment to a fishing line.

4. The jig head of claim 1, the hook having a shank, a bend and a point.

5. The jig head of claim 4, the shank and the bend being co-planar.

6. The jig head of claim 2, the lateral recesses being adapted to receive extension portions of a bait.

7. The jig head of claim 6, the being a soft plastic bait.

8. The jig head of claim 7, the soft plastic bait being an artificial crab.

9. A jig head for fishing, the jig head comprising:
a rear, a curved intermediate portion, a main body, lateral recesses, and a hook, the hook comprising a base;
the hook extending from an upper surface of the rear;
the lateral recesses being positioned adjacent to sides of the hook proximate to the curved intermediate portion;
the jig head further comprising a conical portion and a ridge;
the conical portion surrounding the base of the hook;
the ridge extending outward from the main body;
the ridge, the hook, and the conical portion defining a space.

10. The jig head of claim 9, comprising an eye adapted for attachment to a fishing line.

11. The jig head of claim 9, the hook having a shank, a bend and a point.

12. The jig head of claim 11, the shank and the bend being co-planar.

13. The jig head of claim 9, the lateral recesses being adapted to receive extension portions of a bait.

14. The jig head of claim 13, the being a soft plastic bait.

15. The jig head of claim 14, the soft plastic bait being an artificial crab.

16. A jig head and artificial bait combination used for fishing, the jig head comprising:
a rear, a curved intermediate portion, a main body, lateral recesses, and a hook, the hook comprising a base;
the hook extending from an upper surface of the rear;
the lateral recesses being positioned adjacent to sides of the hook proximate to the curved intermediate portion;
the jig head further comprising a conical portion and a ridge;
the conical portion surrounding the base of the hook;
the ridge extending outward from the main body;
the ridge, the hook, and the conical portion defining a space;
the artificial bait comprising a crab-like configuration such that it is adapted to be threaded onto the hook and onto the conical portion such that an underside of the artificial bait rests against the ridge and such that extension portions of the artificial bait are positioned within the lateral recesses.

17. The jig head of claim 16, comprising an eye adapted for attachment to a fishing line.

18. The jig head of claim 16, the hook having a shank, a bend, and a point.

19. The jig head of claim 18, the shank and the bend being co-planar.
